(19) United States
(12) Patent Application Publication
(10) Pub. No.: US 2012/0079446 A1
(43) Pub. Date: Mar. 29, 2012

(54) SEMICONDUCTOR MODULE DESIGN METHOD AND SEMICONDUCTOR MODULE

(76) Inventors: Hiromichi KUMAKURA, Niiza-shi (JP); Hiroyuki Ogino, Niiza-shi (JP); Kenji Fujimoto, Niiza-shi (JP); Masanori Ueno, Niiza-shi (JP)

(21) Appl. No.: 13/238,935

(22) Filed: Sep. 21, 2011

(30) Foreign Application Priority Data
Sep. 27, 2010 (JP) 2010-215577

(51) Int. Cl. G06F 17/50

(52) U.S. Cl. 716/122

(57) ABSTRACT

A semiconductor module made from a compound semiconductor or diamond and loaded with high performance power semiconductor devices can be obtained at low cost. In a semiconductor module, four (semiconductor chips) of same specifications are arranged in array, two longitudinally and two transversally, on a single lead frame. Achieving a high yield of manufacturing diode chips and reducing the unuseful area of diode chips need to be satisfied at the same time to obtain such a semiconductor module at low cost. The use of an index, which is the product of the yield Y_{Die} of manufacturing chips and the active region area ratio R_{A} is effective for determining them. Thus, semiconductor modules can be obtained at a high yield by selecting a chip size that makes the index close to a peak value depending on the crystal defect density of a wafer to be used.

### BACKGROUND OF THE INVENTION

1. Field of the Invention

The present invention relates to a method of designing a semiconductor module loaded with a power semiconductor chip made from a compound semiconductor or the like. The present invention also relates to a semiconductor module obtained by using the method.

2. Description of the Related Art

Diodes and IGBTs (insulated gate bipolar transistors) made from silicon are being employed as power semiconductor devices designed to operate with a large electric current. A semiconductor chip loaded with such devices is then mounted on a lead frame or the like having a high heat dissipation effect. Such an assembly is formed by molding to produce a semiconductor module.

A semiconductor module may be formed by mounting a plurality of semiconductor chips on a single lead frame. For example, Patent Document 1 (Jpn. Pat. Appln. Laid-Open Publication No. 2004-363339) describes a technique of mounting and arranging semiconductor chips of a plurality of different types on a single lead frame in an ingenious way to make the process of manufacturing a semiconductor module an easy one and allow the module to be downsized.

Patent Document 2 (Jpn. Pat. Appln. Laid-Open Publication No. 2002-100716) describes a technique of optimizing the wiring structure on a lead frame in order to electrically connect a plurality of semiconductor chips with ease and also to make the process of manufacturing a semiconductor module an easy one.

These and other techniques have made it possible to obtain a sophisticated semiconductor module loaded with a plurality of semiconductor chips.

Devices made from a compound semiconductor seem to be promising as high output power semiconductor devices because such a substance shows a bandgap wider than and a dielectric breakdown field higher than silicon. Known compound semiconductors include GaN, AlGaN and SiC. Diamond, which is not a compound, is also regarded as promising. When a diode or a transistor is made from such a material, it shows a breakdown voltage higher than silicon and hence a larger electric current can be made to flow there because of the above described advantages as semiconductor material.

However, while silicon is a material that allows crystal growth in a relatively easy manner and hence its crystallinity can be enhanced with ease, crystal growth is very difficult to such compound semiconductors and diamond and hence it is difficult to obtain a wafer showing a high degree of crystallinity. For example, while a substantially defect-free silicon wafer having a diameter of 300 mm can be obtained on a commercial basis, crystal defects are found in a wafer of such a material having a diameter of about 2 inches to a non-negligible extent. Of such crystal defects, those that are electrically active cause a leak current in a diode when the diode is reverse-biased to give rise to degradation of its high voltage characteristics.

For this reason, it is difficult for power semiconductor devices made from a compound semiconductor or diamond to perform to an expected degree. Additionally, it is difficult to obtain high-performance power semiconductor devices made from such a material at low cost. Thus, power semiconductor devices made from such a material are less popular than semiconductor devices made from silicon. This statement also holds true for semiconductor modules loaded with a plurality of semiconductor chips.

In short, it has been difficult to obtain a semiconductor module made from a compound semiconductor or diamond and loaded with high performance power semiconductor devices at low cost.

### SUMMARY OF THE INVENTION

In view of the above-identified problems, it is therefore an object of the present invention to provide a method of designing a semiconductor module that can dissolve the problems.

According to the present invention, the above object is achieved by providing a method of designing a semiconductor module having a plurality of semiconductor chips produced from a same wafer with same specifications and connected in parallel, the method including: a total area determining step of determining the total area of the plurality of semiconductor chips by means of a selected allowable current of the semiconductor module; and a chip specifications setting step of setting the area A of each semiconductor chip and setting the number of semiconductor chips to be loaded on the semiconductor module so as to make the index defined as the product of R_{A} and Y_{Die} exceed a predefined value; R_{A} being the active region area ratio, or the ratio of the active area in operation of each semiconductor chip relative to the chip area; Y_{Die} being defined by formula (1) shown below:

$$\begin{matrix}[ Mathematical formula 1 ] & \\ {Y}_{Die} = {( \frac{1}{1 + \frac{{AD}_{0}}{α}} )}^{α} , & ( 1 )\end{matrix}$$

where

A is the chip area of each semiconductor chip;

D₀ is the surface density of electrically active crystal defects on the wafer; and

α is a clustering coefficient.

In the chip specifications setting step of the semiconductor module design method as defined above, the area A of each semiconductor chip and the number of semiconductor chips are so set as to make D₀ to be not greater than 5 defects/cm² and the index to be not less than 0.5.

In another aspect of the present invention, there is provided a semiconductor module designed by the semiconductor module design method, the module including a plurality of semiconductor chips connected in parallel and arranged on a lead frame.

In the semiconductor module as defined above, the chip area of each semiconductor chip is within a range between 0.005 cm² and 0.1 cm².

In the semiconductor module as defined above, the chip area of each semiconductor chip is within a range between 0.02 cm² and 0.05 cm².

The semiconductor module as defined above includes four or more than four semiconductor chips.

In the semiconductor module as defined above, the semiconductor chips are diode chips.

In the semiconductor module as defined above, the wafer is formed by single crystal of GaN, AlGaN, SiC or diamond.

Thus, the present invention as described above can provide a semiconductor module loaded with high performance power semiconductor devices made from a compound semiconductor or made from diamond at low cost.

### BRIEF DESCRIPTION OF THE DRAWINGS

FIG. 1 is a schematic perspective view of a semiconductor module according to an embodiment of the present invention, showing the configuration thereof;

FIG. 2 is a graph illustrating the relationship between the chip yield Y_{Die} and the chip area A, using the crystal defect density D₀ as parameter;

FIG. 3A is a schematic partial plan view of diode chips (semiconductor chips) having a small chip area;

FIG. 3B is a schematic partial plan view of diode chips (semiconductor chips) having a large chip area;

FIG. 4 is a graph illustrating the relationship among. Y_{Die}, the active region area ratio R_{A} and the chip area A;

FIG. 5 is a graph illustrating the relationship between the index employed in an embodiment of the present invention and the chip area, using the crystal defect density D₀ as parameter;

FIG. 6A is a graph illustrating the forward characteristics of a semiconductor module (diodes) according to an embodiment of the present invention; and

FIG. 6B is a graph illustrating the backward characteristics of the embodiment of semiconductor module (diodes) according to the embodiment of the present invention.

### DETAILED DESCRIPTION OF THE PREFERRED EMBODIMENTS

Now, a semiconductor module design method and a semiconductor module according to an embodiment of the present invention will be described below. A plurality of semiconductor chips made from a material showing a bandgap wider than and a dielectric breakdown field higher than silicon such as a compound semiconductor or diamond are mounted on the semiconductor module. Note, however, that it is difficult to obtain a wafer by means of such a material with a level of crystallinity same as that of silicon. Examples of compound semiconductor include GaN, AlGaN and SiC. Diamond is also among such materials. Shottky barrier diodes (SBDs) are formed on the semiconductor chips as power semiconductors operating with high power.

Single crystal wafers of silicon showing crystallinity of such a degree that the influence of crystal defects on the characteristics of semiconductor devices is negligible are obtained by cutting bulk crystal produced by means of FZ (floating zone) method or CZ (Czochralsky) method. On the other hand, it is extremely difficult to obtain a large diameter single crystal wafer of a compound semiconductor or diamond by way of a crystal growth process. Typically, GaN and AlGaN are obtained by way of a hetero epitaxial growth process, using a sapphire substrate, and SiC is obtained by way of a sublimation growth process while diamond is obtained by way of high temperature and high-pressure synthesis. Crystal defects are not negligible in a wafer with a diameter of 2 inches that is made of any of such materials.

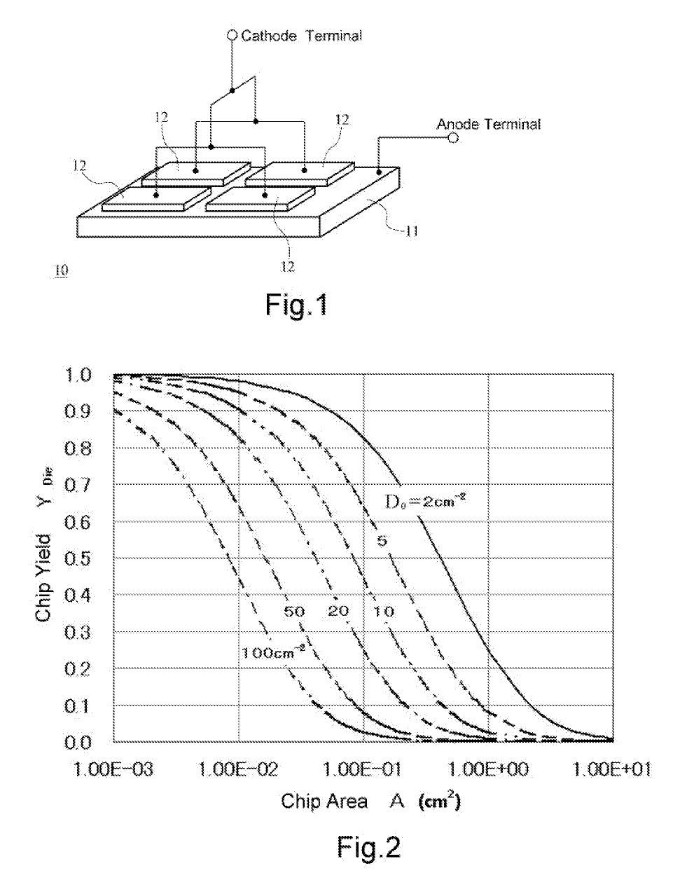

FIG. 1 is a schematic perspective view of a semiconductor module 10 obtained by means of a design method according to the present invention, conceptually illustrating the configuration thereof. In the semiconductor module 10, four diode chips (semiconductor chips) 12 prepared according to same specifications are mounted on a single lead frame 11 in two rows. Each of the diode chips 12 shows a square plan view. An anode electrode is formed on the rear surface of each of the diode chips 12. The anode electrodes of the diode chips are then connected to the electroconductive lead frame 11 and collectively taken out to the outside as a common anode terminal. On the other hand, the cathode electrodes of the diode chips 12 are taken out at the respective top surfaces and then collectively to the outside as a common cathode terminal. Thus, in the semiconductor module 10, four diode chips 12 of same specifications are connected in parallel and a common anode terminal and a common cathode terminal thereof are taken out to the outside. In actuality, the structure of FIG. 1 is sealed with a molding material.

The diode chips 12 are made from a material such as a compound semiconductor or diamond showing a bandgap wider than and a dielectric breakdown field higher than silicon. They operate as diodes as a Schottky contact is formed on the surface of each of them. The diode chips 12 can be obtained by dicing a single crystal wafer of any of the above described materials. Note that the size of a diode chip 12 is typically several mm at each side, whereas a wafer has a diameter of not less than 2 inches. Thus, a large number of diode chips 12 of same specifications can be obtained from a single wafer.

With the semiconductor module design method, it is assumed that the crystal defect density of the wafer to be used is not negligible and the size and the number of diode chips 12 that results in an excellent yield for manufacturing semiconductor modules are selected according to the design method. The yield Y_{Die} of manufacturing semiconductor chips involving such crystal defects is typically given by formula (2) shown below when a YMDB (Yield Model & Defect Budget) model described in “International Technology Roadmap for Semiconductors, 2007, Yield Enhancement (JEITA)” is employed.

$$\begin{matrix}[ Mathematical formula 2 ] & \\ {Y}_{Die} = {Y}_{S} * {Y}_{R} = {Y}_{S} * {( \frac{1}{1 + \frac{{AD}_{0}}{α }} )}^{α} & ( 2 )\end{matrix}$$

In the above formula, Y_{S} is the yield attributable to systematic factors such as overlapping accuracy of the stepper to be employed, Y_{R} is the yield attributable to random factors, which are mostly crystal defects that are randomly distributed, A is the chip area, D₀ is the density (surface density) of electrically influential crystal defects (that have influence on the characteristics of semiconductor devices), such defects being assumed to be randomly distributed in the wafer surface and a is a clustering coefficient having a value of about 2. Note that the density of crystal defects corresponds to the density of etch pits of the wafer that is empirically obtained. The ratio of the crystal defects that have electric influence relative to the total crystal defects is about 1%. Thus, D₀ has a value obtained by multiplying the density of etch pits by that ratio.

While D₀ can be regarded to be nearly 0 in a silicon wafer having a diameter of 300 mm, it is mostly within a range between 2 defects/cm² and 100 defects/cm² in a single crystal wafer of a compound semiconductor. Thus, the influence of D₀ on the yield of manufacturing diode chips 12 from such a wafer is not negligible. FIG. 2 is a graph illustrating the relationship between the chip yield Y_{Die} and the chip area A when D₀ is in the above range, using D₀ as parameter. In the formula (2), it is assumed Y_{S}=1, Y_{S} being the yield attributable to systematic factors. As the chip area is increased, the possibility that the device region contains crystal defects rises and hence the possibility that crystal defects have influence on the device behavior rises to by turn lower the yield. The extent of lowering the yield is remarkable when D₀ has a large value. In other words, the yield attributable to crystal defects that are randomly distributed in the wafer surface rises as the chip size is reduced. For example, when a diode chip 12 is formed by using SiC, the density of crystal defects thereof is about 50 defects/cm². Thus, if the size of the diode chip 12 is 2 mm square (0.09 cm²), the yield of manufacturing such chips is not lower than 50%, which is remarkably low when compared with semiconductor chips made from silicon. This means that the density of crystal defects significantly influence the yield when diode chips 12 are manufactured by using SiC as source material.

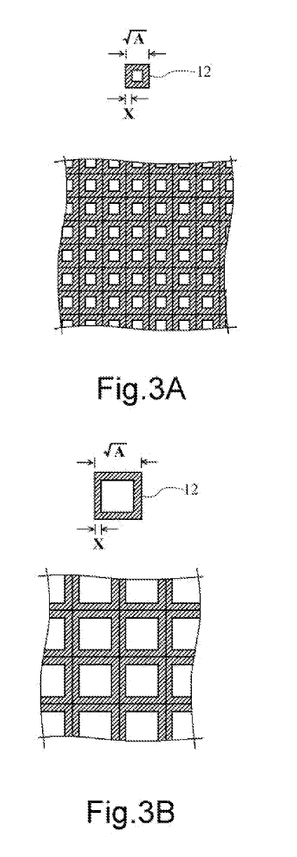

FIGS. 3A and 3B schematically illustrate in the upper areas thereof the structures of diode chips 12 as viewed from above. FIG. 3A shows a small diode chip 12 and FIG. 3B shows a large diode chip 12. A Schottky contact is formed in each of the diode chips 12 and the region of the device where a Schottky contact is formed operates as active region. However, a region with a structure for making the breakdown voltage of the device higher, or a region to be used for dicing when producing the chip, is required around the active region. Those regions are an inactive region where no operating current directly flows. The length of each of the sides of the diode chip 12 is equal to f (A) and the inactive region that is the shaded area in each of FIGS. 3A and 3B has a width of X at each side of the device. The operating current of the diode can be increased by forming a large active region. The chip area A has to be increased to produce a large active region as shown in FIG. 3B. However, in general, the width X of the inactive region practically does not depend on the size of the diode chip 12 and hence has a substantially constant value. Diode chips 12 formed in array on a wafer are shown in the lower area of each of FIGS. 3A and 3B. The area ratio of the active region relative to the total area of each diode chip 12 (active region area ratio R_{A}) is expressed by formula (3) shown below.

$$\begin{matrix}[ Mathematical formula ] & \\ {R}_{A} = \frac{A - 2 \cdot X \cdot \sqrt{A} + {X}^{2}}{A} & ( 3 )\end{matrix}$$

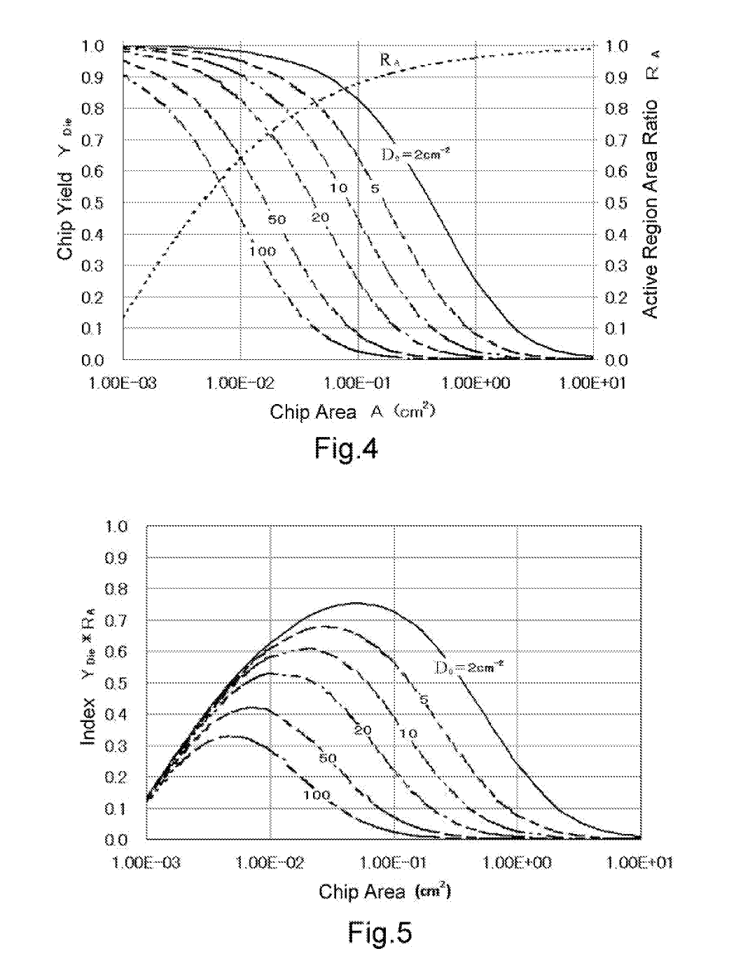

FIG. 4 shows the dependency of the active region area ratio R_{A} on the chip area A when the width X of the inactive area is 200 μm along with the relationship between Y_{Die} and the chip area A. That the active region area ratio R_{A} is small means that the area that serves as active region is small. As pointed out above, when the chip size is small, the chip yield Y_{Die} can be raised but the active region area ratio R_{A} falls. In other words, the area that does not directly participate in the operation, or the unuseful area, of the device increases.

When, on the other hand, the semiconductor module 10 is employed as power device, each diode chip 12 is driven to operate by a large electric current. The allowable current of each diode chip 12 is determined as a function of the area of its active region (Schottky junction), which is by turn determined as a function of the size of the diode chip 12. When the diode chips 12 are small, a large number of diode chips 12 need to be connected in parallel to secure the allowable current to a satisfactory level.

Thus, when a certain value is given to the allowable current, the total area of the plurality of diode chips 12 is determined. Then, the size and the number of diode chips 12 that are to be connected in parallel are determined on the basis of the characteristics shown in FIG. 2 from the viewpoint of raising the yield of manufacturing diode chips 12 on one hand and on the basis of the characteristics shown in FIG. 4 from the viewpoint of minimizing the unuseful area of each diode chip 12 on the other hand. Both the requirement of raising the yield of manufacturing diode chips 12 and the requirement of minimizing the unuseful area of each diode chip need to be met in order to produce a semiconductor module 10 at low cost. Thus, the index that is the product of the chip yield Y_{Die} and the active region area ratio R_{A} is useful. FIG. 5 is a graph illustrating the chip area dependency of the index, using the crystal defect density D₀ as parameter. The value of the index rises as the crystal defect density of the wafer to be used is reduced. Then, semiconductor modules 10 can be obtained at a high yield by selecting a chip size that brings the index close to a peak.

From FIG. 5, it will be seen that the peak value (maximum value) of the index varies as a function of the value of D₀ and is small when D₀ is large. However, the index takes a value close to the peak value of each characteristic curve so long as the chip area is within a range between 0.005 cm² and 0.14 cm² provided that D₀ is within a range between 2 defects/cm² and 100 defects/cm². In other words, semiconductor modules can be obtained at low cost by making the chip area to be found within a range between 0.005 cm² (about 0.7 mm square) and 0.14 cm² (about 3.8 mm square) when the value of D₀ is found within the above range.

On the basis of the above description, for the method of designing a semiconductor module 10, firstly, the value of the allowable current is defined for the standard of the semiconductor module 10. Then, as a result, the total area of the plurality of diode chips (semiconductor chips) 12 is determined (the total area determining step).

Then, the surface density D₀ of electrically active crystal defects of the wafer to be used for manufacturing diode chips 12 is determined. This can be determined by observing the density of etch pits, using an appropriate etchant that matches the crystal defects. The length of the inactive region X is determined by the outer peripheral structure for the high breakdown voltage of diode chips 12, the dicing line width and so on. Then, Y_{Die} is determined for a certain chip area A by using these values and the formula (2) and R_{A} is calculated by using the formula (3). Finally, the chip area A is determined so as to make the index, which is the product of Y_{Die} and R_{A}, to be found within a range that exceeds a predetermined value (the chip specifications setting step). The total number of diode chips 12 is so selected as to make the total area equal to the value determined in the total area determining step for the chip area A.

With the above-described design method, the specifications and the number of diode chips 12 are determined for the semiconductor module 10. As shown in FIG. 1, the determined number of diode chips 12 are loaded on the lead frame 11 and the anode electrodes and the cathode electrodes thereof are connected in parallel. Then, semiconductor modules 10 can be manufactured at low cost and at a high yield.

A semiconductor module that can be driven with a large electric current can be obtained at low cost by using only a single diode chip or two diode chips having a large area if the diode chip is or the diode chips are made from silicon with very few crystal defects. To the contrary, when diode chips are manufactured by using a compound semiconductor or diamond whose crystal defect density cannot be reduced, a semiconductor module 10 can be obtained at low cost by reducing the size of each individual diode chip 12 and using a large number of diode chips 12, four or more diode chips 12 in particular.

A compound semiconductor wafer showing a small crystal defect density is more expensive than a compound semiconductor wafer showing a large crystal defect density. However, with the above described structure and the design method, a semiconductor module that can be driven with a large electric current can be obtained at low cost without using such an expensive wafer.

It is clear that a large value may advantageously be selected for the index (the product of Y_{Die} and R_{A}) to reduce the unuseful area of each diode chip 12 and obtain semiconductor modules 10 at a high yield. Thus, for example, the value of the index is preferably not less than 0.5. However, the peak value depends on D₀ and falls when D₀ is large. Therefore, in order to secure a sufficiently wide range for the chip size (chip area) that makes the index not less than 0.5, it is particularly preferable that D₀ is not greater than 5 defects/cm². Then, the range of the chip area that makes the index not less than 0.65 is particularly preferably between 0.02 cm² and 0.05 cm² for the purpose of maintaining the value of the index close to the peak value for D₀=5 defects/cm² in FIG. 5.

While FIG. 1 shows a semiconductor module prepared by arranging four diode chips 12 in array, two longitudinally and two transversally, any arrangement of diode chips can feasibly be used for a semiconductor module according to the present invention. The number and arrangement of diode chips 12 may be selected appropriately by taking the heat dissipation effect and other factors into consideration. Note, however, that a two-dimensional arrangement is advantageous from the viewpoint of downsizing the semiconductor module 10 when a large number of diode chips 12 are to be arranged. A large number of diode chips 12 can be connected in parallel with ease when the anode electrode and the cathode electrode of each diode chip 12 is formed respectively on the bottom surface and on the top surface of the diode chip 12.

While a semiconductor module is formed by SBD chips as semiconductor chips in the above description, the present invention can also be applied to instances of manufacturing pn-junction diodes or transistors as semiconductor chips whose operating current (allowable current) is determined by the chip size, made from a material whose crystal defect density cannot be reduced. Then, a large number of semiconductor chips having a small area are connected in parallel to form a semiconductor module, while determining the chip area of each semiconductor chip and the number of semiconductor chips by means of the above described design method, to obtain a semiconductor module that can allow a predefined electric current to flow at low cost.

### EXAMPLE

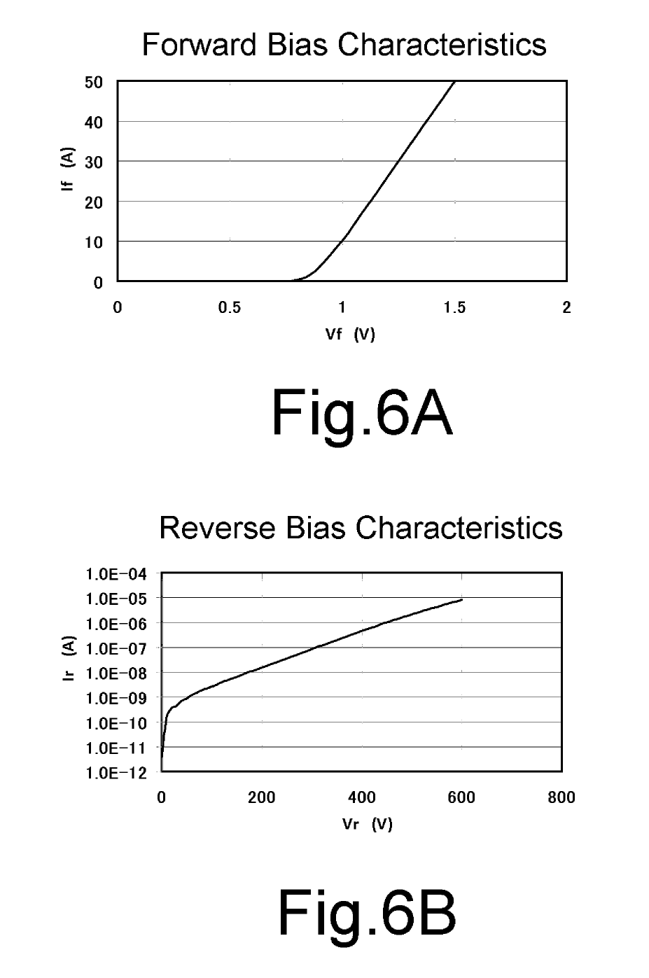

In an example, diodes were manufactured (for a semiconductor module) by using an SiC wafer whose D₀ was 40 defects/cm². The allowable current was about 50 A. The size of the diode chips was 2 mm square (X=200 μm). With this chip size (0.04 cm²), Y_{Die}=0.31 and R_{A}=0.81. Thus, a value close to the peak value in the relationship between the index and the chip area A for D₀=40 defects/cm² was obtained. The yield of manufacturing semiconductor molecules (allowable current: 48 A), each having 6 diode chips of this size connected in series, was about 30%. FIG. 6A and FIG. 6B respectively show the forward bias characteristics and the reverse bias characteristics of the semiconductor modules. The yield of manufacturing semiconductor modules (allowable current: 50 A), each having a single diode chip with a sufficiently secured chip area, was about 2%, although they showed similar characteristics. While D₀=40 defects/cm² in this example, it will be clear that a higher yield can be achieve by reducing D₀.

What is claimed is:

1. A method of designing a semiconductor module having a plurality of semiconductor chips produced from a same wafer with same specifications and connected in parallel, the method comprising:
a total area determining step of determining the total area of the plurality of semiconductor chips by means of a selected allowable current of the semiconductor module; and
a chip specifications setting step of setting the area A of each semiconductor chip and setting the number of semiconductor chips to be loaded on the semiconductor module so as to make the index defined as the product of R_{A} and Y_{Die} exceed a predefined value;
R_{A} being the active region area ratio, or the ratio of the active area in operation of each semiconductor chip relative to the chip area;
Y_{Die} being defined by formula (1) shown below:
$$\begin{matrix}[ Mathematical formula 1 ] & \\ {Y}_{Die} = {( \frac{1}{1 + \frac{{AD}_{0}}{α}} )}^{α} & ( 1 )\end{matrix}$$
where
A is the chip area of each semiconductor chip;
D₀ is the surface density of electrically active crystal defects on the wafer; and
α is a clustering coefficient.

2. The semiconductor module design method according to claim 1, wherein the area A of each semiconductor chip and the number of semiconductor chips are so set as to make D₀ to be not greater than 5 defects/cm² and the index to be not less than 0.5 in the chip specifications setting step.

3. A semiconductor module designed by the semiconductor module design method according to claim 1, comprising a plurality of semiconductor chips connected in parallel and arranged on a lead frame.

4. The semiconductor module according to claim 3, wherein the chip area of each semiconductor chip is within a range between 0.005 cm² and 0.14 cm².

5. The semiconductor module according to claim 3, wherein the chip area of each semiconductor chip is within a range between 0.02 cm² and 0.05 cm².

6. The semiconductor module according to claim 3, comprising four or more than four semiconductor chips.

7. The semiconductor module according to claim 3, wherein the semiconductor chips are diode chips.

8. The semiconductor module according to claim 3, wherein the wafer is formed by single crystal of GaN, AlGaN, SiC or diamond.
